(19) United States
(12) Patent Application Publication
(10) Pub. No.: US 2026/0178827 A1
(43) Pub. Date: Jun. 25, 2026

(54) APPLICATION INTEGRATION VIA MULTIMODAL GENERATIVE MODEL-ASSISTED WEB BROWSING

(71) Applicant: Microsoft Technology Licensing, LLC, Redmond, WA (US)

(72) Inventors: Aamir JAWAID, Renton, WA (US); Siddharth UPPAL, Bothell, WA (US)

(21) Appl. No.: 18/999,554

(22) Filed: Dec. 23, 2024

(51) Int. Cl. G06F 40/197; G06F 9/48; G06F 40/40; G06V 30/42

(52) U.S. Cl. CPC G06F 40/197; G06F 9/4881; G06F 40/40; G06V 30/42

(57) ABSTRACT

A technique for integrating applications through web interface automation uses natural language instructions and multimodal AI to interact with target applications without requiring APIs. An application handler receives requests from client applications and provides configuration data including a website address, natural language task instructions, and completion criteria. A web task orchestration service processes screenshots through a perception agent that marks interactive elements, while a multimodal language model analyzes the marked screenshots and determines appropriate actions. A browser agent executes the actions on the web interface until completion criteria are met. The technique enables seamless integration between applications by leveraging existing web interfaces rather than requiring dedicated API development.

### TECHNICAL FIELD

The present disclosure relates generally to software integration frameworks and automated web interaction systems. More particularly, the disclosure relates to methods and systems for enabling seamless integration between applications using artificial intelligence (AI) driven web interface automation and task optimization. The disclosure describes techniques for utilizing large multimodal language models with AI vision capabilities to interact with web-based user interfaces, bypassing traditional application programming interface (API) requirements while maintaining programmatic accessibility. The technical field encompasses AI, computer vision, and software integration, particularly focusing on autonomous web navigation frameworks that can interpret and interact with web-based user interfaces to execute application functions. The disclosure further relates to systems and methods for optimizing web task execution through semantic matching and modification of previously successful interaction patterns. Specifically, the disclosure describes techniques for generating reusable task records that capture successful web interface interactions and efficiently adapting those patterns to complete similar tasks, reducing computational costs while maintaining reliability.

### BACKGROUND

The use of websites as a primary means of communication, collaboration, and information sharing has become ubiquitous in modern society. Websites are easy to design and deploy, making them accessible to individuals, small businesses, medium-sized enterprises, and large organizations alike. The proliferation of user-friendly development tools, content management systems, and web hosting services has democratized web development, enabling even those with limited technical expertise to create and maintain robust web applications.

### BRIEF DESCRIPTION OF THE DRAWINGS

Embodiments of the present invention are illustrated by way of example and not limitation in the figures of the accompanying drawings, in which:

FIGS. 1A and 1B are block diagrams illustrating conventional approaches for accessing application functionality through a web browser and application programming interfaces (API), respectively.

FIG. 2 is a block diagram illustrating a system architecture for enabling application integration via web interface automation, consistent with embodiments described herein.

FIG. 3 is a block diagram illustrating components of a web task orchestration service and AI model service, consistent with embodiments described herein.

FIG. 4 is a sequence diagram illustrating interactions between system components during task execution using vision-based web interface automation, consistent with embodiments described herein.

FIG. 5 is a block diagram illustrating generation and storage of task records based on successful task completions, consistent with embodiments described herein.

FIG. 6 is a sequence diagram illustrating interactions between system components during task execution using cached task records, consistent with embodiments described herein.

FIG. 7 is a block diagram illustrating a software architecture that may be installed on devices implementing embodiments described herein.

FIG. 8 is a block diagram illustrating a hardware architecture for devices implementing embodiments described herein.

### DETAILED DESCRIPTION

Described herein are techniques for enabling seamless integration between applications through artificial intelligence (AI) driven web interface automation. The disclosed techniques utilize large multimodal language models and computer vision capabilities to interact with web-based user interfaces, bypassing traditional application programming interface (API) requirements while maintaining programmatic accessibility. In particular embodiments, the system employs a web task orchestration service that processes natural language requests from client applications, like Microsoft Teams®, and intelligently navigates target application websites to complete requested tasks. The system can optimize task execution by generating and reusing task records that capture successful interaction patterns, reducing computational costs while maintaining reliability. Through the combination of vision-based webpage analysis, natural language understanding, and semantic matching of similar tasks, the system enables efficient integration between collaborative platforms and third-party applications without requiring dedicated API development. In the following description, numerous specific details are provided to enable a thorough understanding of various aspects of the disclosed embodiments. It will be apparent to one skilled in the art that certain embodiments may be practiced without some or all of these specific details.

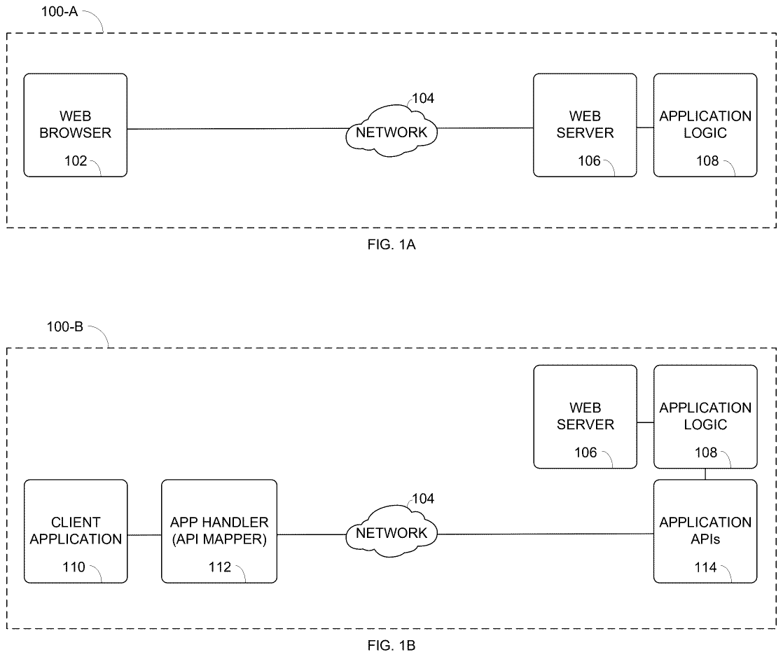

The use of websites as a primary means of communication, collaboration, and information sharing has become ubiquitous in modern society. As illustrated in FIG. 1A, a typical web-based application includes application logic 108 that is accessible through a web server 106 via a web browser 102 over a network 104. This web-based architecture has made deploying and maintaining applications accessible to individuals, small businesses, medium-sized enterprises, and large organizations alike. Websites can be easily designed and maintained using standard web technologies and development tools. The proliferation of user-friendly development tools, content management systems, and web hosting services has democratized web development, enabling even those with limited technical expertise to create and maintain robust web applications.

Websites serve diverse purposes, ranging from e-commerce and customer support to internal collaboration and social interaction. They are often preferred over traditional desktop applications due to their accessibility across devices and platforms, as they can be accessed through standard web browsers without requiring additional installation or configuration. Moreover, advances in web technologies allow developers to create feature-rich, dynamic, and interactive user experiences through web interfaces.

Client applications that facilitate messaging services, such as Microsoft Teams®, Slack®, WhatsApp®, and similar platforms, have also become integral to modern communication and collaboration. These applications enable users to send and receive messages, share files, and integrate with other tools to enhance productivity. As shown in FIG. 1B, traditionally extending the functionality of these applications to interoperate with external systems has required implementing both application APIs 114 and a special type of application or event handler, referred to here as an API mapper 112, to enable the client application 110 to communicate with the application logic 108. This API-based integration approach requires significant development effort from application providers to implement and maintain the necessary API endpoints and integration code.

Despite their widespread use, APIs impose significant technical and resource constraints, particularly for smaller organizations or individual developers. As illustrated in the transition from FIG. 1A to FIG. 1B, enabling programmatic access to web-based application logic requires creating and maintaining additional software components beyond the basic web interface. The API development process involves careful design, implementation, testing, documentation, and ongoing maintenance to ensure reliable integration capabilities.

In light of these challenges, there is a growing need for solutions that enable seamless integration between client applications and web-based applications without relying on APIs. Such solutions would simplify the process of extending the capabilities of client applications, reduce the dependency on extensive development resources, and promote greater flexibility in leveraging web-based tools alongside messaging services.

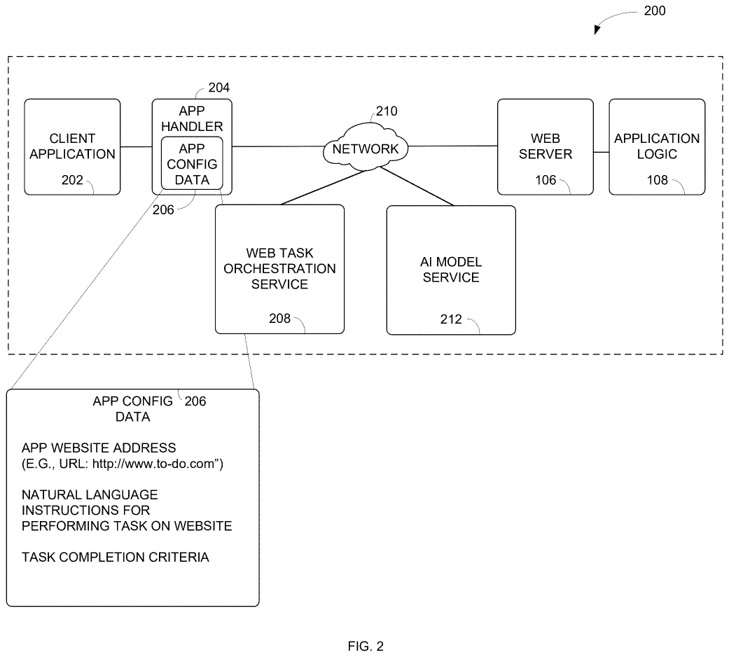

Described herein are innovative techniques addressing the challenges of API-based integration through an AI-driven web interface automation system 200, as illustrated in FIG. 2. Rather than requiring complex API development and maintenance, the system 200 enables integration through a simplified application handler 204 that stores basic application configuration data 206. Consistent with some embodiments, this application configuration data 206 includes just three key elements: a website address (e.g., a URL) for accessing the target application, natural language instructions describing how to perform tasks on the website, and task completion criteria.

For example, to enable adding items to a to-do list, the application configuration data might include the website address “www. to-do. com”, natural language instructions such as “Click the ‘Add Item’ button, enter the task text in the input field that appears, then click the ‘Save’ button”, and completion criteria specified as “The newly added item appears in the to-do list”. This simple configuration approach allows developers to quickly enable integration without implementing complex APIs.

As shown in FIG. 2, when a client application 202 (e.g., such as Microsoft Teams®) sends a request to perform a task, the application handler 204 forwards both the request and the corresponding application configuration data to the web task orchestration service 208. The web task orchestration service 208 then works in conjunction with the AI model service 212 to intelligently interact with the web interface of the target application, accessing the application logic 108 through the web server 106 over the network 210.

This approach offers several significant advantages over traditional API-based integration. First, it dramatically reduces the development burden on application providers, who need only provide simple application configuration data rather than implementing complex APIs. Second, it enables integration with any web-accessible application, regardless of whether they expose formal APIs. Third, the system's use of multimodal language models with AI vision capabilities and natural language processing allows it to adapt to changes in web interfaces without requiring updates to integration code. Finally, the solution enables rapid integration of new applications by leveraging their existing web interfaces rather than waiting for API development.

While the AI-driven web interface automation system 200 described above offers significant advantages over traditional API-based integration, the approach introduces certain computational challenges. Specifically, the iterative process of capturing screenshots of web pages, analyzing them with the multimodal language model, and determining a next action to perform can be both time-consuming and computationally expensive. Each interaction with the AI model service requires significant processing resources, particularly when using vision-based reasoning capabilities to interpret webpage content and determine appropriate actions.

To address these performance challenges, the system implements an innovative optimization strategy that leverages past successful interactions to dramatically reduce the computational overhead of processing similar requests. Consistent with some embodiments, when a user submits a request to perform a task, the system first generates an embedding representing the task objective. This embedding is then compared against stored embeddings from previously completed tasks to identify “matching” task records that contain proven sequences of browser agent actions.

When a matching task record is found, rather than initiating the full vision-based reasoning process, the system retrieves the stored sequence of browser agent actions and efficiently adapts them for the current request using a single call to a generative language model. For example, if the system previously learned how to add “mow the lawn” to a to-do list, it can quickly modify those same browser actions to add “do laundry” without needing to rediscover the entire interaction pattern through multiple AI model calls.

This optimization approach significantly reduces both latency and computational costs while maintaining the ability of the system to successfully complete requested tasks. The stored task records effectively serve as a cache of proven interaction patterns that can be rapidly adapted and reused. Additionally, if the modified actions fail due to website changes or other factors, the system can seamlessly fall back to the original vision-based interaction approach to rebuild its understanding of how to complete the task. Other aspects and advantages of the various embodiments will be readily apparent from the detailed descriptions of the several drawings that follows.

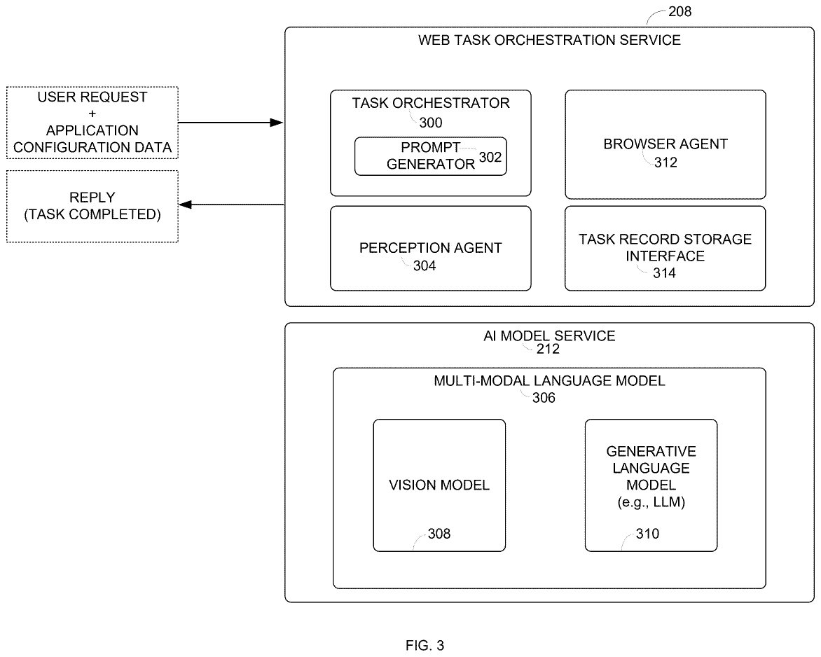

FIG. 3 illustrates components of the web task orchestration service 208 and AI model service 212 that enable automated web interface interaction, consistent with some embodiments. The web task orchestration service 208 includes a task orchestrator 300 that receives user requests and application configuration data and coordinates the overall task execution process. Within the task orchestrator 300, a prompt generator 302 creates prompts for the AI model service 212 based on captured screenshots and task objectives.

The perception agent 304 processes screenshots of web pages, encoding them by overlaying identifiers on interactive elements to help the multimodal language model 310 understand the webpage structure. For example, when analyzing a webpage, the perception agent 304 marks buttons, text fields, and other interactive elements with unique labels that the model can reference in its responses.

The perception agent uses Set-of-Mark (SOM) prompting techniques to enhance the multimodal model's ability to understand and interact with webpage elements. Using specialized libraries, the perception agent analyzes the webpage's Document Object Model (DOM) structure to identify all interactive elements like buttons, input fields, and navigation controls. For each detected element, the agent extracts properties including element IDs, CSS selectors, and ARIA labels.

The perception agent then overlays unique identifiers or “hints” next to each interactive element-for example, labeling a button as “A” or an input field as “B” creating a mapping between the visual hints and the underlying HTML element identifiers. This markup process enables reliable interaction, as it allows the multimodal model to unambiguously specify which elements should be interacted with when determining the next actions to take. The marked-up screenshots reduce hallucination and improve the model's ability to ground its understanding in the actual webpage structure.

The browser agent 312 handles direct interaction with web pages, executing actions like clicking buttons, entering text, and navigating between pages based on instructions received from the task orchestrator 300. The browser agent 312 also captures screenshots of web pages for analysis by the perception agent 304.

The task record storage interface 314 manages the storage and retrieval of task records that contain successful interaction patterns. These records include metadata about interactive elements, text inputs, and navigation actions that were used to complete tasks.

The AI model service 212 includes a multimodal language model 306 with two key components: a vision model 308 that analyzes webpage screenshots, and a generative language model 310 that determines appropriate actions based on the visual analysis and natural language instructions. The AI model service 212 may be implemented as a remote service accessible over a network, or alternatively, may be deployed locally using the same computing resources as the web task orchestration service 208. While shown as separate components in FIG. 3, the vision model 308 and generative language model 310 may be implemented as sub-components of a larger unified multimodal model in various embodiments. Here, the specific architectural arrangement shown in the figure is intended to be illustrative rather than limiting.

In operation, when a user request is received along with application configuration data, the task orchestrator 300 initiates the process by directing the browser agent 312 to access the target website. The perception agent 304 then captures and processes a screenshot, which the prompt generator 302 combines with the task objective to create a prompt for the multi-modal language model 306.

The vision model 308 analyzes the marked-up screenshot while the generative language model 310 interprets the natural language instructions to determine the next action. The model returns a structured response specifying which interactive elements to engage with and what actions to perform. The browser agent 312 executes these actions, and the process repeats until the task completion criteria are satisfied.

Upon successful task completion, the task orchestrator 300 sends a reply to the application handler indicating the task has been completed. The system may also store the successful interaction pattern through the task record storage interface 314 for future use.

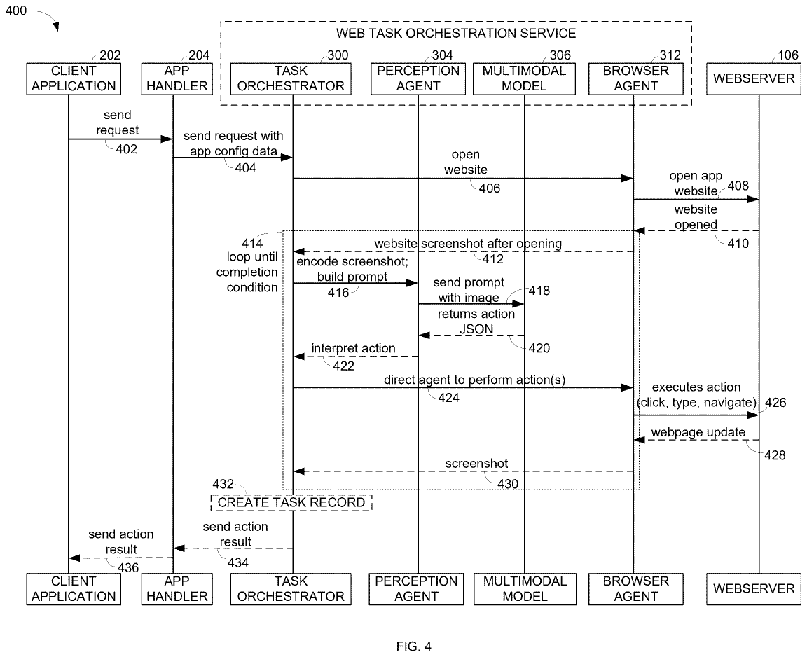

FIG. 4 is a sequence diagram 400 illustrating interactions between system components during task execution using vision-based web interface automation, consistent with embodiments described herein. The process begins when a user sends a natural language request 402 through the client application 202 (e.g., Microsoft Teams®) to add an item to their to-do list. For example, the user might type “add do laundry to my to-do list”. The client application 202 sends this user request 402 to the app handler 204.

Upon receiving the request, the app handler 204 packages it with the application configuration data 404, which includes the website address (e.g., “www. to-do. com”), natural language instructions (e.g., “Click the ‘Add Item’ button, enter the task text, then click Save”), and completion criteria (e.g., “The newly added item appears in the to-do list”). The app handler 204 forwards this package to the task orchestrator 300, as shown by reference number 404.

The task orchestrator 300 initiates the web interface navigation process by directing the browser agent 312 to open the target website 406, using the address included in the application configuration data as received at step 404. The web server 106 processes this request 408 and confirms when the website is accessible 410. The perception agent 304 then captures or receives 412 a screenshot of the webpage and processes it by overlaying identifiers on interactive elements-for example, labeling buttons and input fields with unique markers like “A” or “B” to help the AI model reference them precisely.

Within the main execution loop 414, the perception agent 304 encodes each received screenshot 416 and builds a prompt combining the marked-up screenshot with the task objective. This enhanced screenshot 416 is sent 418 to the multimodal model 306, which analyzes the image and returns structured JSON 420, specifying exactly which labeled element to interact with (e.g., “Click button labeled ‘A’ to add new item”).

The task orchestrator 300 interprets these instructions 422 and directs the browser agent 312 to perform specific actions 424-clicking buttons, entering text like “do laundry”, or navigating pages. The browser agent 312 executes these actions 426, and the web server 106 responds with updated webpage content 428.

After each action, a new screenshot 430 is captured to verify the results. The system checks if the completion criteria are met-in this example, confirming that “do laundry” appears in the to-do list. The task orchestrator 300 also creates a detailed task record 432 documenting the successful interaction pattern, including the specific elements interacted with and text entered.

Consistent with some embodiments, during task execution, the task orchestrator 300 continuously records each action and its results as they occur. After each action, a new screenshot 430 is captured and analyzed against the completion criteria. If the completion criteria are not satisfied, the system may need to attempt different sequences of actions-for example, if clicking one button doesn't lead to the desired result, the system may backtrack and try an alternative path through the interface.

Only when the completion criteria are fully satisfied does the task orchestrator 300 finalize the task record 432. This record captures the complete successful interaction pattern, including detailed metadata about each interactive element accessed, text entered, and navigation steps taken. The task record is particularly valuable as it documents a proven sequence of actions that successfully achieved the task objective.

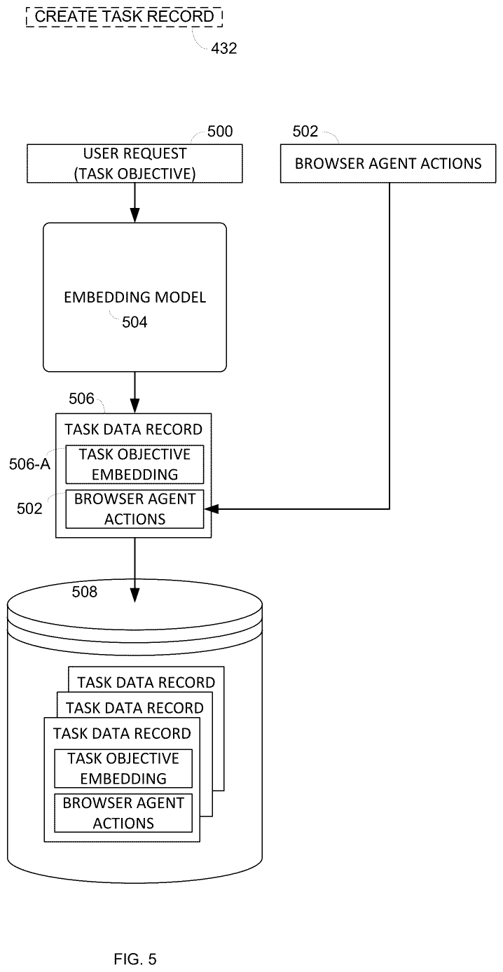

Once the task is completed successfully, the action result is sent back through the app handler 434 to the client application 436, confirming completion to the user. The entire process demonstrates how the system not only completes the immediate task but also builds a knowledge base of successful interaction patterns by recording and validating each sequence of actions that leads to task completion. This recorded history becomes especially valuable for optimizing future similar requests through the task record matching system described in FIG. 5.

FIG. 5 illustrates the process of generating and storing task data records for optimizing future task execution. When a task is successfully completed, the system processes the user request (e.g., the task objective) 500 through an embedding model 504 to generate a task objective embedding 506-A. This embedding 506-A represents the semantic meaning of the task request in a format that enables efficient comparison with other task objectives.

The system combines this task objective embedding 506-A with the sequence of browser agent actions 502 that successfully completed the task. These browser agent actions 502 include the specific sequence of interactions with webpage elements, such as clicking buttons, entering text, or navigating between pages. The combined embedding and actions form a task data record 506 that is stored in a database 508, or other storage, containing multiple such records.

For subsequent user requests, the system generates an embedding of the new request or task objective, using the same embedding model 504. This new task objective embedding is then compared against stored task objective embeddings in the database 508 using one of several techniques:

For example, with some embodiments, the system may calculate cosine similarity scores between the new task objective embedding and each stored embedding, considering matches when scores exceed a defined threshold. Alternatively, the system may measure semantic distance between embeddings in the vector space, identifying matches within a predetermined proximity. In yet another embodiment, the system may employ clustering algorithms to group similar embeddings, considering embeddings in the same cluster as potential matches.

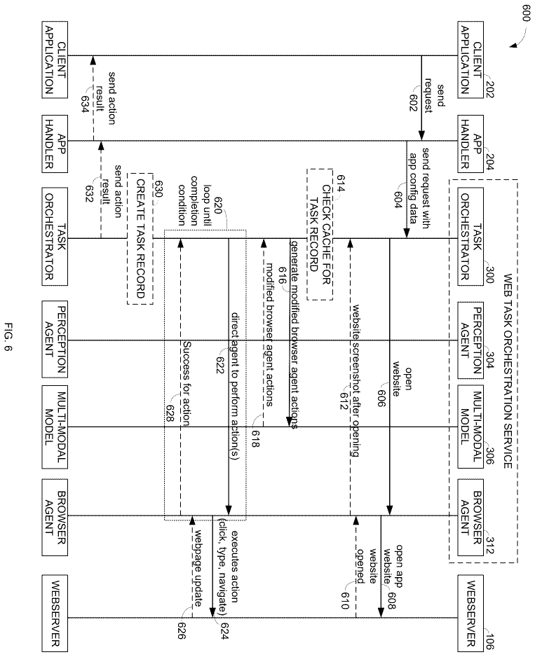

In any case, when a matching task record is identified, the system retrieves its associated browser agent actions. These actions are then modified as needed to accommodate the specific parameters of the new request or task objective-for example, adjusting text input values while maintaining the same interaction pattern with the webpage. This approach enables efficient task completion by leveraging previously successful interaction patterns rather than rediscovering them through repeated AI model calls. This optimization technique is further described in connection with the description of FIG. 6, which immediately follows.

FIG. 6 is a sequence diagram illustrating interactions between system components during task execution using cached task data records, consistent with embodiments described herein. The sequence begins when a client application 202 sends a user request 602 to the app handler 204, which forwards the user request along with application configuration data 604 to the task orchestrator 300.

The task orchestrator 300 initiates the process by directing the browser agent 312 to open the target website 606. After the web server 106 confirms access 610, the system captures an initial screenshot 612 of the webpage. At this point, rather than immediately beginning vision-based analysis, the task orchestrator performs a check 614 to determine if a matching task data record exists in the cache.

The system generates an embedding for the current task objective, for example, based on the text of the user request, and compares it against stored task objective embeddings to identify similar previously completed tasks. When a matching task data record is found, the system generates modified browser agent actions 616 by providing the existing action sequence to a generative language model along with instructions to adapt it for the current task objective. For example, if the system previously learned how to add “mow lawn” to a to-do list, it can efficiently modify those actions to add “do laundry” instead.

The task orchestrator receives the modified browser agent actions 618 and enters a loop 620 to execute them through the browser agent 312. For each action, the browser agent performs the specified operation 624 (e.g., clicking, typing, or navigating) and receives webpage updates 626 in response. The system verifies successful execution 628 after each action.

Upon successful completion of all actions, the system may create a new task data record 630 capturing the modified interaction pattern. Finally, the action result is sent back through the app handler 632, 634 to confirm completion to the user. This optimized approach significantly reduces computational costs by reusing and adapting proven interaction patterns rather than rediscovering them through repeated vision-based analysis.

When changes are made to a target website's structure or interface elements, the browser agent may fail to successfully execute the modified sequence of browser agent actions. For example, if element identifiers or page layouts have changed, the browser agent may be unable to locate specific buttons, input fields, or other interactive elements referenced in the stored task data record.

In such cases, the system seamlessly falls back to its vision-based interaction mode. The task orchestrator retrieves the original configuration data, including the website address, natural language instructions, and completion criteria, and initiates the full vision-based discovery process. The perception agent captures new screenshots and marks up interactive elements, while the multimodal model analyzes each screenshot to determine appropriate actions, effectively rediscovering how to complete the task with the updated webpage structure.

Upon successfully completing the task through vision-based interaction, the system generates a new task data record with updated browser agent actions that reflect the current webpage structure. This new task record replaces the previous one in storage, ensuring that future attempts to complete similar tasks will use the correct, updated sequence of actions that work with the modified website interface. This self-healing capability enables the system to maintain reliable operation even as target websites evolve over time.

### Machine and Software Architecture

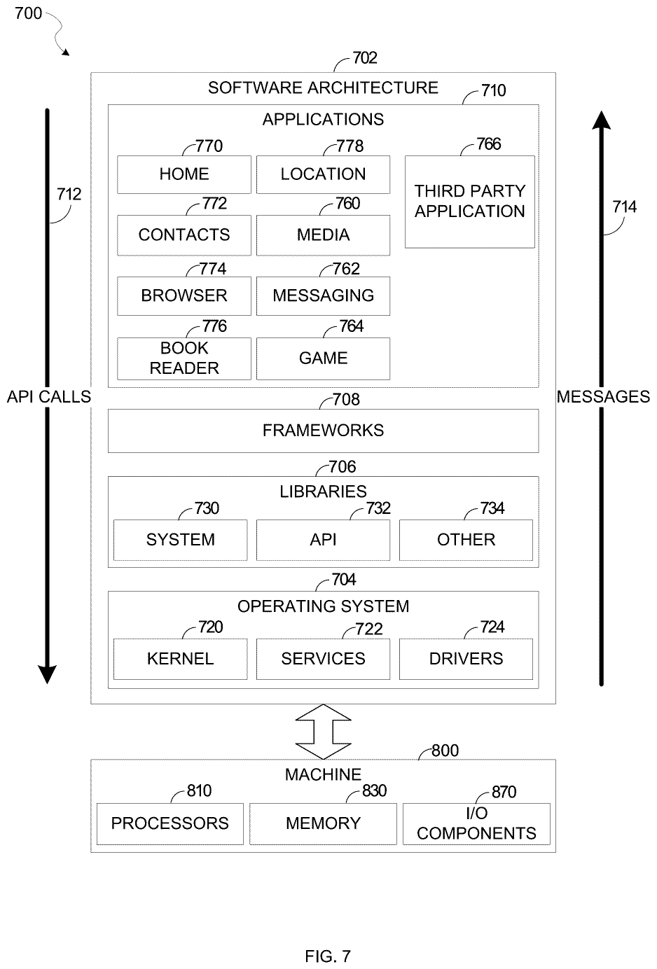

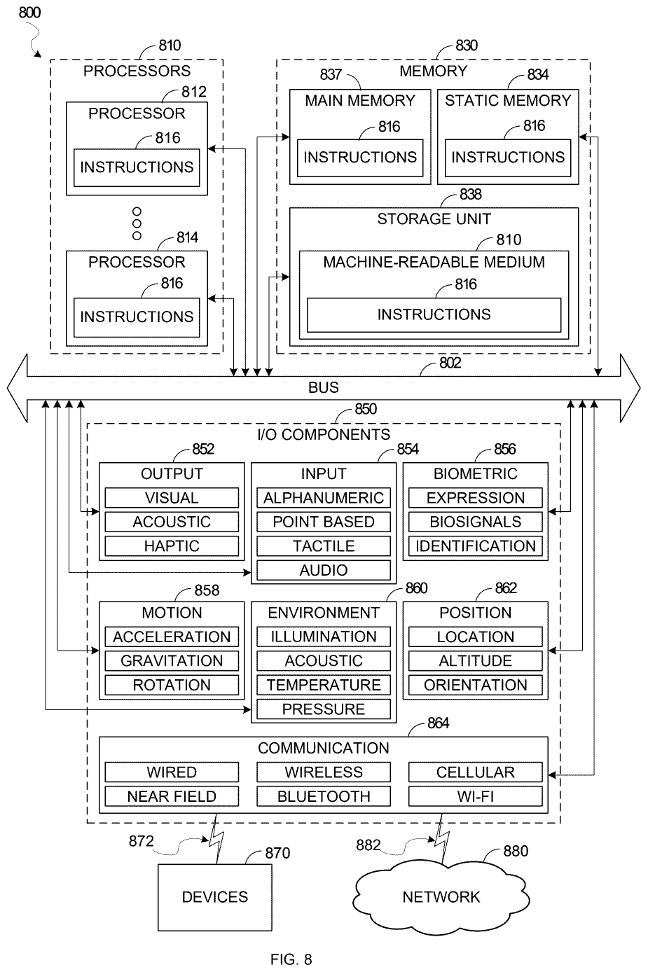

FIG. 7 is a block diagram 700 illustrating a software architecture 702, which can be installed on any of a variety of computing devices to perform methods consistent with those described herein. FIG. 7 is merely a non-limiting example of a software architecture, and it will be appreciated that many other architectures can be implemented to facilitate the functionality described herein. In various embodiments, the software architecture 702 is implemented by hardware such as a machine 800 of FIG. 8 that includes processors 810, memory 830, and input/output (I/O) components 850. In this example architecture, the software architecture 702 can be conceptualized as a stack of layers where each layer may provide a particular functionality. For example, the software architecture 702 includes layers such as an operating system 704, libraries 706, frameworks 708, and applications 710. Operationally, the applications 710 invoke API calls 712 through the software stack and receive messages 714 in response to the API calls 712, consistent with some embodiments.

In various implementations, the operating system 704 manages hardware resources and provides common services. The operating system 704 includes, for example, a kernel 720, services 722, and drivers 724. The kernel 720 acts as an abstraction layer between the hardware and the other software layers, consistent with some embodiments. For example, the kernel 720 provides memory management, processor management (e.g., scheduling), component management, networking, and security settings, among other functionality. The services 722 can provide other common services for the other software layers. The drivers 724 are responsible for controlling or interfacing with the underlying hardware, according to some embodiments. For instance, the drivers 724 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 706 provide a low-level common infrastructure utilized by the applications 710. The libraries 706 can include system libraries 730 (e.g., C standard library) that can provide functions such as memory allocation functions, string manipulation functions, mathematic functions, and the like. In addition, the libraries 706 can include API libraries 732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 706 can also include a wide variety of other libraries 734 to provide many other APIs to the applications 710.

The frameworks 708 provide a high-level common infrastructure that can be utilized by the applications 710, according to some embodiments. For example, the frameworks 708 provide various GUI functions, high-level resource management, high-level location services, and so forth. The frameworks 708 can provide a broad spectrum of other APIs that can be utilized by the applications 710, some of which may be specific to a particular operating system 704 or platform.

In an example embodiment, the applications 710 include a home application 750, a contacts application 752, a browser application 754, a book reader application 756, a location application 758, a media application 760, a messaging application 762, a game application 764, and a broad assortment of other applications, such as a third-party application 766. According to some embodiments, the applications 710 are programs that execute functions defined in the programs. Various programming languages can be employed to create one or more of the applications 710, structured in a variety of manners, such as object-oriented programming languages (e.g., Objective-C, Java, or C++) or procedural programming languages (e.g., C or assembly language). In a specific example, the third-party application 766 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 766 can invoke the API calls 712 provided by the operating system 704 to facilitate functionality described herein.

FIG. 8 illustrates a diagrammatic representation of a machine 800 in the form of a computer system within which a set of instructions may be executed for causing the machine to perform any one or more of the methodologies discussed herein, according to an example embodiment. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example the instructions 816 may cause the machine 800 to execute any one of the methods or algorithmic techniques described herein. Additionally, or alternatively, the instructions 816 may implement any one of the systems described herein. The instructions 816 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory 830, and I/O components 850, which may be configured to communicate with each other such as via a bus 802. In an example embodiment, the processors 810 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 812 and a processor 814 that may execute the instructions 816. The term “processor” is intended to include multi-core processors that may comprise two or more independent processors (sometimes referred to as “cores”) that may execute instructions contemporaneously. Although FIG. 6 shows multiple processors 810, the machine 800 may include a single processor with a single core, a single processor with multiple cores (e.g., a multi-core processor), multiple processors with a single core, multiple processors with multiples cores, or any combination thereof.

The memory 830 may include a main memory 832, a static memory 834, and a storage unit 836, all accessible to the processors 810 such as via the bus 802. The main memory 830, the static memory 834, and storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 may include a wide variety of components to receive input, provide output, produce output, transmit information, exchange information, capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 6. The I/O components 850 are grouped according to functionality merely for simplifying the following discussion and the grouping is in no way limiting. In various example embodiments, the I/O components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 850 may include biometric components 856, motion components 858, environmental components 860, or position components 862, among a wide array of other components. For example, the biometric components 856 may include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 862 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a USB).

Moreover, the communication components 864 may detect identifiers or include components operable to detect identifiers. For example, the communication components 864 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 864, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 830, 832, 834, and/or memory of the processor(s) 810) and/or storage unit 836 may store one or more sets of instructions and data structures (e.g., software) embodying or utilized by any one or more of the methodologies or functions described herein. These instructions (e.g., the instructions 816), when executed by processor(s) 810, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 880 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 816 may be transmitted or received over the network 880 using a transmission medium via a network interface device (e.g., a network interface component included in the communication components 864) and utilizing any one of a number of well-known transfer protocols (e.g., HTTP). Similarly, the instructions 816 may be transmitted or received using a transmission medium via the coupling 872 (e.g., a peer-to-peer coupling) to the devices 070. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 816 for execution by the machine 800, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A method performed by a web task orchestration service for integrating a client application with a target application, the method comprising:
receiving, from an application handler, a request and configuration data comprising: i) a website address for accessing the target application via a web interface, ii) natural language instructions describing steps for completing a task via the web interface, and iii) a completion condition expressed in natural language;
initiating a browser session to access the target application using the website address;
iteratively performing until the completion condition is satisfied:
capturing a screenshot of a webpage of the target application;
generating a prompt based on the screenshot;
transmitting the prompt and screenshot to a multi-modal language model and receiving a next action;
directing a browser agent to perform the next action on the webpage;
receiving an updated webpage in response to performing the next action; and
analyzing the updated webpage to determine whether the completion condition is satisfied; and
providing a result to the client application indicating completion of the task.

2. The method of claim 1, wherein generating the prompt comprises:
encoding the screenshot by overlaying numerical or symbolic marks on regions of the screenshot to create a marked screenshot, wherein the marks identify distinct interactive elements within the webpage.

3. The method of claim 2, wherein transmitting the prompt and screenshot comprises:
transmitting the marked screenshot to a vision model component of the multi-modal language model for visual analysis of the marked regions; and
transmitting the prompt to a generative language model component of the multi-modal language model for determining the next action based on results of the visual analysis; and
receiving the next action comprises receiving a structured Javascript Object Notation (JSON) response from the multi-modal language model, wherein the JSON response specifies:
one or more of the marked regions identified by their corresponding marks; and
one or more actions to be performed by the browser agent on interactive elements within the identified marked regions.

4. The method of claim 3, wherein analyzing the updated webpage to determine whether the completion condition is satisfied comprises:
providing the updated webpage and the completion condition to the vision model component of the multi-modal language model;
receiving from the vision model component an indication of whether visual elements matching the completion condition are present in the updated webpage; and
when the visual elements are not present, continuing the iterative performance of actions until the completion condition is satisfied.

5. The method of claim 1, wherein analyzing the updated webpage to determine whether the completion condition is satisfied comprises:
capturing a screenshot of the updated webpage;
providing the screenshot and completion condition to the multi-modal language model;
receiving from the multi-modal language model an indication of whether the completion condition is satisfied; and
when the completion condition is not satisfied, initiating error handling procedures.

6. The method of claim 5, wherein the error handling procedures comprise:
providing the screenshot and natural language instructions to the multi-modal language model to determine corrective actions;
directing the browser agent to perform the corrective actions; and
analyzing a subsequent webpage to verify the corrective actions resolved the error.

7. The method of claim 1, wherein the natural language instructions comprise:
a sequence of high-level task descriptions for navigating the web interface of the target application.

8. The method of claim 1, wherein analyzing the updated webpage to determine whether the completion condition is satisfied comprises:
providing the updated webpage and the completion condition to the vision model component of the multi-modal language model;
receiving from the vision model component an indication of whether visual elements matching the completion condition are present in the updated webpage; and
when the visual elements are not present, continuing the iterative performance of actions until the completion condition is satisfied.

9. The method of claim 1, wherein receiving the request comprises:
providing the request to a generative language model;
receiving from the generative language model an identification of a target application from multiple available target applications;
retrieving configuration data associated with the identified target application, wherein the configuration data includes the website address, natural language instructions, and completion condition for accessing the identified target application; and
wherein providing the request and configuration data to the web task orchestration service comprises providing the configuration data for the identified target application.

10. The method of claim 1, further comprising:
generating, by the web task orchestration service upon successful completion of the task, a task data record comprising:
data describing each action performed by the browser agent to complete the task, wherein the data includes:
identifiers of interactive elements accessed on the webpage,
text input provided to text entry fields, and
navigation actions performed;
screenshots captured during task execution;
the configuration data used to complete the task; and
an embedding representing the task objective derived from the user request; and
storing the task record in association with the embedding in a task data record database maintained by the web task orchestration service.

11. A system for integrating a client application with a target application, the system comprising:
at least one processor; and
at least one memory storage device storing instructions thereon, which, when executed by the at least one processor, cause the system to perform operations comprising:
receiving, from an application handler, a request and configuration data comprising: i) a website address for accessing the target application via a web interface, ii) natural language instructions describing steps for completing a task via the web interface, and iii) a completion condition expressed in natural language;
initiating a browser session to access the target application using the website address;
iteratively performing until the completion condition is satisfied:
capturing a screenshot of a webpage of the target application;
generating a prompt based on the screenshot;
transmitting the prompt and screenshot to a multi-modal language model and receiving a next action;
directing a browser agent to perform the next action on the webpage;
receiving an updated webpage in response to performing the next action; and
analyzing the updated webpage to determine whether the completion condition is satisfied; and
providing a result to the client application indicating completion of the task.

12. The system of claim 11, wherein generating the prompt comprises:
encoding the screenshot by overlaying numerical or symbolic marks on regions of the screenshot to create a marked screenshot, wherein the marks identify distinct interactive elements within the webpage.

13. The system of claim 12, wherein transmitting the prompt and screenshot comprises:
transmitting the marked screenshot to a vision model component of the multi-modal language model for visual analysis of the marked regions; and
transmitting the prompt to a generative language model component of the multi-modal language model for determining the next action based on results of the visual analysis;
and receiving the next action comprises receiving a structured Javascript Object Notation (JSON) response from the multi-modal language model, wherein the JSON response specifies:
one or more of the marked regions identified by their corresponding marks; and
one or more actions to be performed by the browser agent on interactive elements within the identified marked regions.

14. The system of claim 13, wherein analyzing the updated webpage to determine whether the completion condition is satisfied comprises:
providing the updated webpage and the completion condition to the vision model component of the multi-modal language model;
receiving from the vision model component an indication of whether visual elements matching the completion condition are present in the updated webpage; and
when the visual elements are not present, continuing the iterative performance of actions until the completion condition is satisfied.

15. The system of claim 11, wherein analyzing the updated webpage to determine whether the completion condition is satisfied comprises:
capturing a screenshot of the updated webpage;
providing the screenshot and completion condition to the multi-modal language model;
receiving from the multi-modal language model an indication of whether the completion condition is satisfied; and
when the completion condition is not satisfied, initiating error handling procedures.

16. The system of claim 15, wherein the error handling procedures comprise:
providing the screenshot and natural language instructions to the multi-modal language model to determine corrective actions;
directing the browser agent to perform the corrective actions; and
analyzing a subsequent webpage to verify the corrective actions resolved the error.

17. The system of claim 11, wherein the natural language instructions comprise:
a sequence of high-level task descriptions for navigating the web interface of the target application.

18. The system of claim 11, wherein analyzing the updated webpage to determine whether the completion condition is satisfied comprises:
providing the updated webpage and the completion condition to the vision model component of the multi-modal language model;
receiving from the vision model component an indication of whether visual elements matching the completion condition are present in the updated webpage; and
when the visual elements are not present, continuing the iterative performance of actions until the completion condition is satisfied.

19. The system of claim 11, wherein receiving the request comprises:
providing the request to a generative language model;
receiving from the generative language model an identification of a target application from multiple available target applications;
retrieving configuration data associated with the identified target application, wherein the configuration data includes the website address, natural language instructions, and completion condition for accessing the identified target application; and
wherein providing the request and configuration data to the web task orchestration service comprises providing the configuration data for the identified target application.

20. A memory storage device storing instructions thereon, which, when executed by at least one processor, cause a system to perform operations comprising:
receiving, from an application handler, a request and configuration data comprising: i) a website address for accessing the target application via a web interface, ii) natural language instructions describing steps for completing a task via the web interface, and iii) a completion condition expressed in natural language;
initiating a browser session to access the target application using the website address;
iteratively performing until the completion condition is satisfied:
capturing a screenshot of a webpage of the target application;
generating a prompt based on the screenshot;
transmitting the prompt and screenshot to a multi-modal language model and receiving a next action;
directing a browser agent to perform the next action on the webpage;
receiving an updated webpage in response to performing the next action; and
analyzing the updated webpage to determine whether the completion condition is satisfied; and
providing a result to the client application indicating completion of the task.
